(19) United States
(12) Patent Application Publication
(10) Pub. No.: US 2015/0115044 A1
(43) Pub. Date: Apr. 30, 2015

(54) THERMOSTAT UNIT

(71) Applicant: DBK David + Baader GmbH, Rulzheim (DE)

(72) Inventors: Katherine Claber, Billingshurst (GB); Gary Silk, Greenville, SC (US)

(73) Assignee: DBK David + Baader GmbH

(21) Appl. No.: 14/525,527

(22) Filed: Oct. 28, 2014

Related U.S. Application Data
(60) Provisional application No. 61/896,775, filed on Oct. 29, 2013.

(30) Foreign Application Priority Data
Oct. 29, 2013 (DE) 10 2013 111 925.5

(51) Int. Cl. G05D 23/19; G01K 1/08

(52) U.S. Cl. CPC G05D 23/19; G01K 1/08
USPC 236/49.3; 374/208

(57) ABSTRACT

Disclosed is a thermostat unit having at least two thermostats, which are held at a normed rail. The two thermostats are arranged transversely to the rail axis.

### CROSS-REFERENCE TO RELATED APPLICATIONS

This application is a Non-Provisional Utility Application and claims priority to U.S. Provisional Application No. 61/896,775 filed on Oct. 29, 2013 and German Application No. DE 10 2013 111 925.5 filed on Oct. 29, 2013, which applications are hereby incorporated by reference in their entirety.

### BACKGROUND

Thermostat units, by which a temperature control is performed according to an ambient temperature, are used for controlling electrical devices, such as heaters or fans.

Temperature control is usually performed by means of bimetallic thermostats, in which having different coefficients of thermal expansion of a bimetallic element is taken advantage of to switch a contact depending on the temperature.

Such bimetallic thermostats are equipped with an adjustment element by means of which the operating point of the thermostat can be adjusted. For example, such bimetallic thermostats are installed in a control cabinet, wherein the control cabinet comprises DIN rails, also called top-hat rails, on which the thermostat and, if appropriate, also other control/switch elements, for example, relays, switches, time switches, or automatic circuit breakers are mounted. These DIN rails are normed (for example EN60715), so that mounting the aforementioned control elements can be performed with uniform mounting means.

It is commonly known to clip thermostats onto such a rail by means of clip elements. For controlling a fan and a heater, for example, two of such thermostats have to be provided, which, for example, open (NC) or close (NO) with increasing temperature, so that a temperature-dependent control of the electrical devices is ensured. Correspondingly, at least two of such thermostats have to be mounted, which requires significant mounting expenditures and installation space.

In order to overcome this disadvantage, thermostat units are known in which two thermostats are incorporated in a joint housing and which can thus be mounted to the DIN rail in one working step. Such thermostat units known as ‘twin thermostats’ are described on www.pfannenberg.de. Since two thermostats are incorporated in a joint housing in such thermostat units, the device-related expenditures are lower as compared to the solutions with separate housings stated at the beginning. Moreover, the installation is simplified, since both thermostats can be set on the DIN rail in one working step.

However, the disadvantage remains that the two adjacent thermostats being accommodated in a joint housing require relatively much space on the rail, so that the installation space for further control components is limited.

### SUMMARY

Disclosed herein is a thermostat unit according to the preamble of patent claim 1, requiring less installation space. Thermostat unit, as used herein, is a unit including two or more thermostats.

Advantages of the disclosure are the subject matter of the dependent claims.

The exemplary thermostat unit has at least two thermostats, which are held at a normed rail, to which further electrical components are mountable. According to the principles of the disclosure, the two thermostats of the thermostat unit are arranged next to/above each other transversely to the rail axis, such that the thermostat axis spanned by the thermostats runs substantially perpendicular to the rail axis.

In other words, the two thermostats are installed transversely with regard to the rail and placed above each other, so that the same or only insignificantly more space is required along the rail as compared to a solution with only one thermostat. Therefore, there is sufficient space left on the rail to mount the further electrical equipment (relays, etc.).

In an exemplary embodiment of the disclosure, the two thermostats are embodied with a joint housing, which has locking elements for locking with the rail. This allows for a simple mounting, since only the joint housing has to be put on the rail. Alternatively, separate housings can be used which are mounted on the rail in a suitable way placed above each other.

The locking elements may, for example, include positioning pieces and opposing latch elements, which can be operatively engaged with the side plates of the rail.

For example, the locking elements may include two positioning pieces which sectionally encompass a side plate and two opposing latch elements which encompass the other side plate in a clip-like manner.

Advantageously, each thermostat is embodied with an operating element for adjusting the respective operating temperature or the operating parameter to be controlled. These operating elements are then adjacently arranged at a major surface of the housing facing away from the rail.

This housing is advantageously formed with inlets for cables or litz wires for contacting the thermostats.

Moreover, access openings for screwing the cables onto contact blocks can be provided at the housing.

These access openings can lead in pairs into a major surface of the housing facing away from the rail and are particularly arranged adjacent to a minor side of the housing, such that the two operating elements of the thermostats are arranged between the pair of access openings.

For example, the housing may include a housing base part, which supports the two thermostats, and a housing cover, which is latched onto the housing base part and has recesses for the operating elements.

The housing base part may include pins for fixating the thermostats.

The housing , for example, may be produced by injection molding and can comprise recesses for preventing material accumulation.

The thermostat unit may include thermostats of the same type or of different types. For example, an ‘opener’ and a ‘closer’ can be provided for controlling a fan and a heater. Basically, also thermostats of the same type, such as two ‘openers’ or two ‘closers’, can be used.

### DESCRIPTION OF THE DRAWINGS

An exemplary embodiment is described below with reference to the drawings. The Figures show:

FIG. 1: an exemplary three-dimensional view of a thermostat unit;

FIG. 2: a front view of the exemplary thermostat unit according to FIG. 1;

FIG. 3: a three-dimensional rear view of the exemplary thermostat unit according to FIG. 1 clipped onto the DIN rail;

FIG. 4: the exemplary thermostat unit according to FIG. 1 with removed housing cover, and

FIG. 5: a housing base part of the exemplary thermostat unit according to FIG. 4.

### DETAILED DESCRIPTION OF THE DRAWINGS

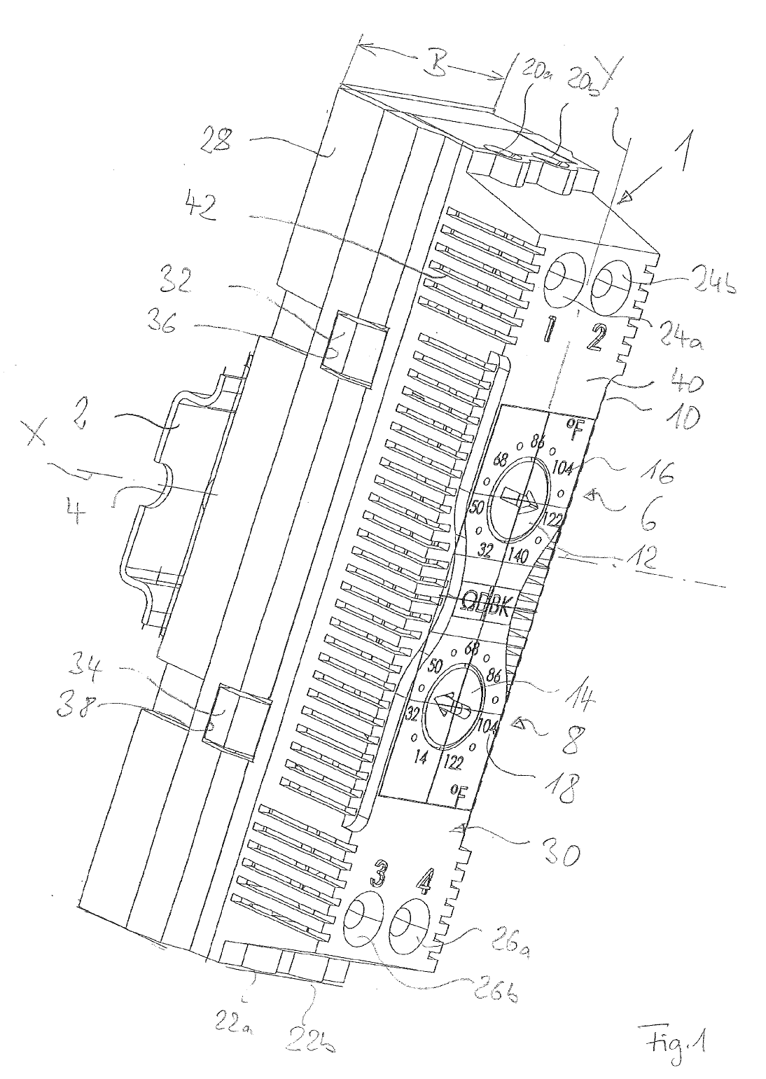

In FIG. 1, an arrangement is shown in which a thermostat unit 1 is arranged at a DIN rail (top-hat rail) 2. In this illustration, only a part of this DIN rail 2 is shown, whose longitudinal extension is significantly longer than is shown in FIG. 1. Such rails 2 are installed in a control cabinet by means of fixation recesses 4 and support corresponding operating equipment by means of which electrical devices or the like can be controlled.

In the example, the thermostat unit 1, to which the rail 2 also belongs in principle, includes two bimetallic thermostats 6, 8, which are arranged in a joint housing 10. This is then clipped on to the rail 2 in a manner described in more detail below. As shown in FIG. 1, the two thermostats 6, 8 are arranged lying above each other along the thermostat axis Y, which runs perpendicularly to the rail axis X. The width B of the housing, in other words the space which is required from the thermostat unit 1 on rail 2, substantially corresponds to the width of a common thermostat, as was described in the beginning. Accordingly, more installation space for further operating equipment is left on the rail 2 than in the conventional solution, so that the utilization of space is significantly improved.

In the exemplary embodiment, two operating elements 12, 14 (turning knobs) and the associated temperature scales 16, 18 of the two thermostats 6, 8 are visible. Moreover, inlets for cables or litz wires 20a, 20b or 22a, 22b respectively, for contacting the thermostats are provided at the housing 10 for each thermostat 6, 8. Fixation of the cables or, litz wires, respectively, inserted in the inlets 20, 22 is performed by screwing (referred to as paternoster clamps), wherein screwing is performed without removing the cover through access openings 24a, 24b or 26a, 26b, respectively.

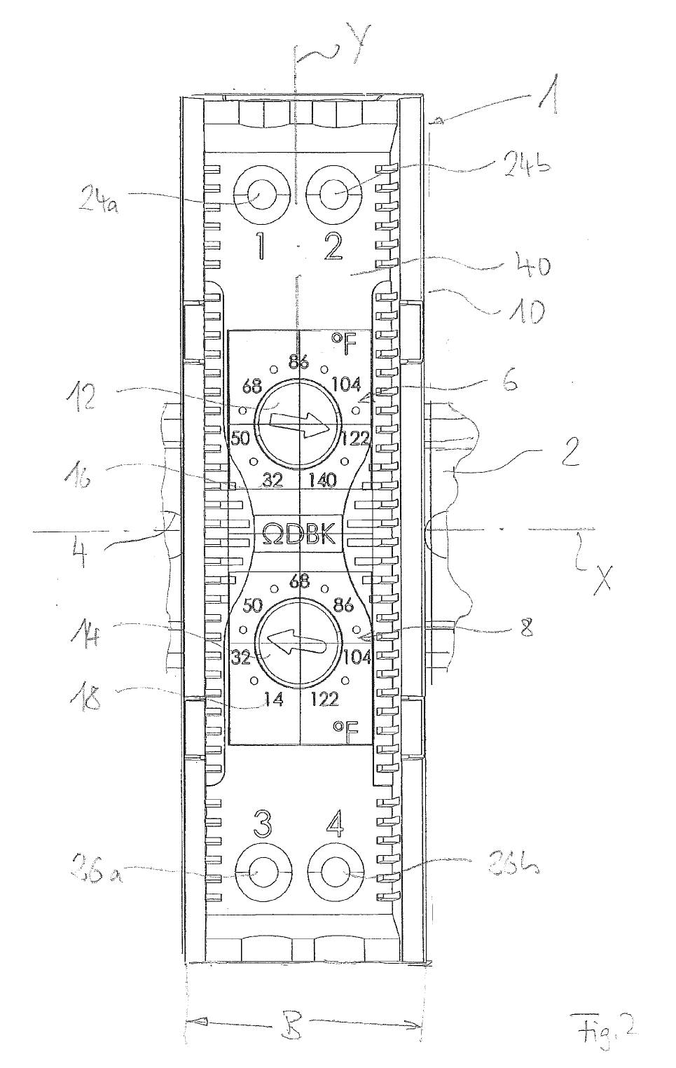

The housing 10 includes a housing base part 28, which is described in more detail below, onto which a housing cover 30 is clipped. Flexible tongues 32, 34 are formed at the housing base part 28 for this clip connection, wherein the flexible tongues 32, 34 engage with corresponding locking recesses 36, 38 of the housing cover 30. A bottom of the housing cover 30 forms a front side 40, into which the access openings 24, 26 lead and on which the scales 16, 18 are arranged. The operating elements 14, 16, which are formed as turning knobs, can be accessed from the front side to set the switching temperature for the associated electrical consumer (fan, heater, etc.). According to the illustrations in FIGS. 1 and 2, the pairs of access openings 24a, 24b, 26a, 26b are arranged adjacently to the minor sides of the housing 10, so that correspondingly, the operating elements 12, 14 and the associated scales 16, 18 are lying between them. Slits 42 are provided at the housing cover 30 for thermally coupling the unit with the environment.

As shown in FIG. 2, the axis Y spanned by the two thermostats 6, 8 runs perpendicularly to the rail axis X, wherein only a part of the rail 2 is shown.

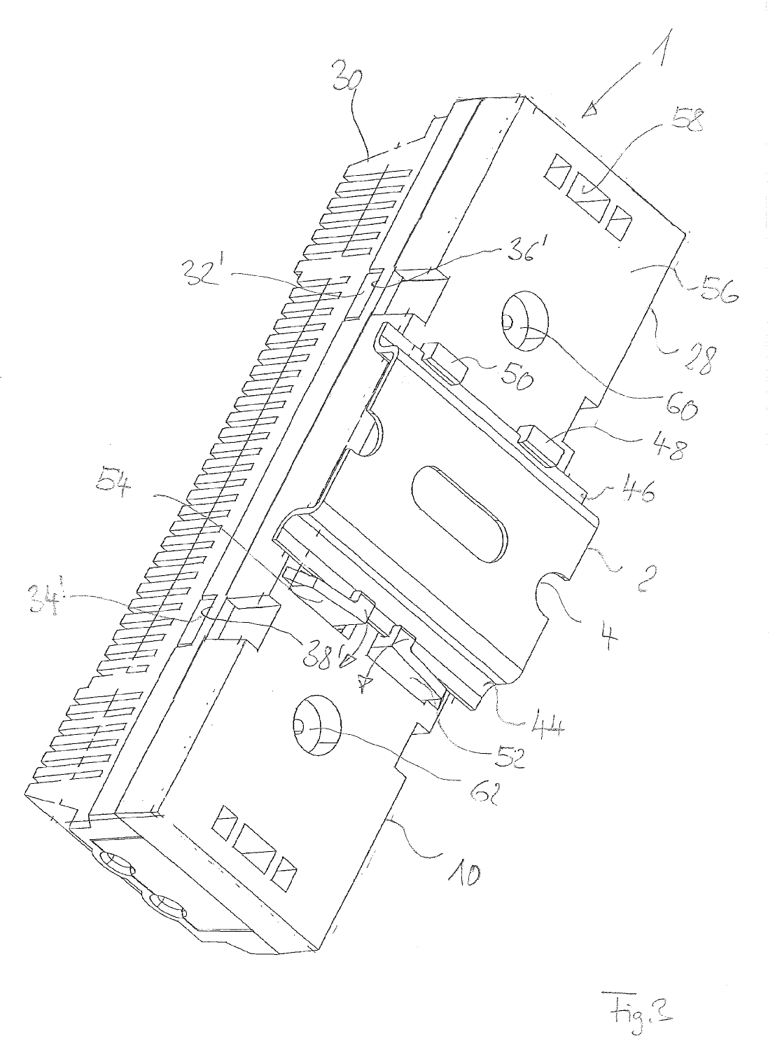

FIG. 3 shows a three-dimensional view of the thermostat unit 1 from a rear side, i.e., from the fixation surface of the control cabinet. In this illustration, the hat-shaped profile of the rail 2 can also be seen quite well, wherein the fixation recesses 4 are formed at a bottom surface, which abuts on the control cabinet. This fixation surface passes into two side plates 44, 46, onto which the housing 10 is clipped. In this illustration, the flexible tongues 32′, 34′ can be seen quite well, which are not visible in FIG. 1; wherein the flexible tongues 32′, 34′ engage with corresponding locking recesses 36′, 38′ to latch the housing base part 28 onto the housing cover 30.

The fixation of the housing 10 onto the rail 2 is performed by locking elements, which for the exemplary embodiment include two positioning pieces 48, 50 and two opposing resilient latch elements 52, 54. These locking elements project from the bottom 56 of the housing base part 28 towards the rail 2. The two positioning pieces 48, 50 are formed such that they form-fittingly encompass the side edge of the side plate 46. The two opposing latch elements 52, 54 are each formed to be resilient and can be swung back in the direction of the arrow (FIG. 3) for attachment to the rail 2, wherein they resiliently snap back into their locking position after attaching, in which the side plate 44 is form-fittingly encompassed. Accordingly, the attaching of the housing 10 is performed by at first attaching the two positioning pieces 50, 48 obliquely to the side plate 46 of the rail 2. Then, the housing 10 is bent towards the rail 2, and thereby the two latch elements 52, 54 are deflected in the direction of the arrow. After resting the housing 10 on the rail 2, the two latch elements 52, 54 then snap back into their shown locking position.

The housing 10 with the housing base part 28 and the housing cover 30 may be made of plastic, for example by injection molding, wherein recesses 58 are provided to prevent material accumulation. These recesses may also be tool-related in order to be able to provide slide elements or the like for forming undercuts.

As further explained below, two pins 60, 62 are provided at the housing base part 28, for mounting the thermostats 6, 8.

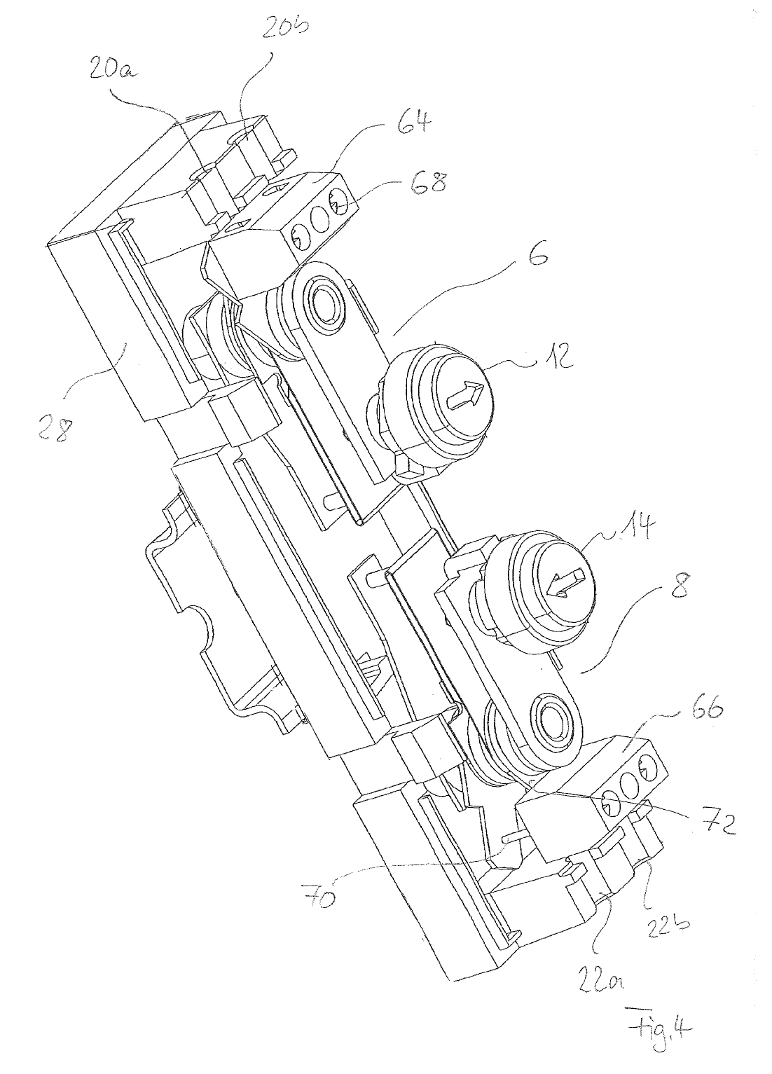

FIG. 4 shows the thermostat unit 1 in a view in which the housing cover 30 is removed. In this view, the two thermostats 6, 8 can be seen, which are fixed on the housing base part 28. The inlets 20a, 20b and 22a, 22b for cables or litz wires, respectively, for contacting the thermostats 6, 8 are also clearly visible. Cables can be led to a terminal block 64 or 66, respectively, through these inlets 20, 22. By means of this terminal block, the cables are contacted by screwing, wherein the screws 68 of each terminal block 64, 66 visible in FIG. 4 are accessible through the associated access openings 24, 26, so that contacting/screwing can be easily accomplished from the front side of the thermostat unit 1.

According to the illustration in FIG. 4, the operating elements 12, 14 are formed as turning knobs. The thermostats 6, 8 are embodied as bimetallic thermostats in a per se known way. Their structure is explained in the prior art described in the beginning, so that reference can be made to these documents with regard to the basic structure of such bimetallic components.

The turning knobs for setting the operating point and the corresponding adjustment elements at the thermostats 6, 8 are made with flat areas or chamfers, etc., to assure that the turning knobs are attached with a correct orientation. Such positioning elements are known per se, and are therefore not included in the Figures.

The contacting of the thermostats 6, 8 from the side of the terminal blocks 66, 68 is performed by electrical connections 70, 72, which are shown in FIG. 4.

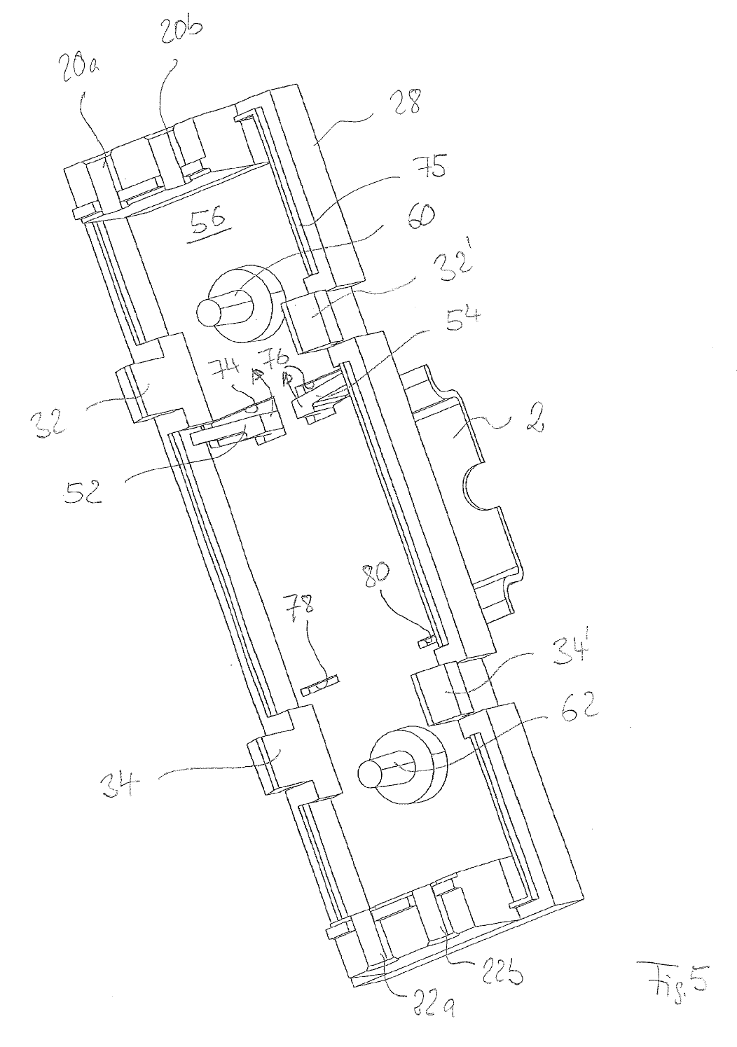

FIG. 5 shows a view of the housing base part 28 without the thermostats 6, 8 and in a state of being clipped on to the rail 2. In this view, the four flexible tongues 32, 34 and 32′, 34′ can be seen which serve for fixation of the housing cover 30. Moreover, a flange edge 75 is visible, onto which the open peripheral wall of the housing cover 30 is placed. The two pins 60, 62, visible also in FIG. 3, onto which the two thermostats 6, 8 are placed, project from the bottom 56 of the housing base part 28. Moreover, the two latch elements 52, 54 are formed in the bottom 56. These are cut free by recesses 74, 76 to enable the aforementioned deflection for latching onto the rail 2. This deflection is again indicated by the arrows in FIG. 5. Two free punches 78, 80 furthermore lead to the bottom 56 through which two tool-side sliding elements are inserted for forming the positioning pieces 48, 50.

The exemplary thermostat unit saves considerable installation space at the rail 2, so that only minor device-related and installation-related space expenditures are required and thus more electrical components can be mounted to a DIN rail 2 than it is the case in the prior art.

The example was explained based on thermostats. In principle, other control/switch elements can be arranged lying above each other transversely to the rail axis X in this manner. The Applicant reserves the right to base a separate claim on this generalization.

Disclosed is a thermostat unit having at least two thermostats, which are held at a normed rail. The two thermostats are arranged transversely to the rail axis.

1-12. (canceled)

13. A system, comprising:
a normed rail and at least two thermostats held at the normed rail; wherein the normed rail is configured to receive further electrical components; and further wherein at least two thermostats are adjacent to one another and are arranged along a thermostat axis transverse to a rail axis, the thermostat axis being substantially perpendicular to the rail axis.

14. The system according to claim 13, further comprising a joint housing encasing the adjacent thermostats, the joint housing including locking elements that are fixable onto the normed rail.

15. The system according to claim 14, wherein the locking elements include positioning pieces and opposing latch elements, the positioning pieces and opposing latch elements being operatively engagable with first and second side plates of the normed rail.

16. The system according to claim 15, wherein the two positioning pieces sectionally encompass the first side plate and the two latch elements sectionally encompass the second side plate.

17. The system according to claim 14, wherein each thermostat includes an operating element, wherein the operating elements are arranged adjacently to each other at a front side of the joint housing facing away from the normed rail.

18. The system according to claim 17, wherein the joint housing further includes inlets for at least one of cables and litz wires for contacting of the thermostats and access openings for screwing the cables to terminal blocks.

19. The system according to claim 18, wherein the access openings are arranged in pairs at the front side facing away from the rail and adjacent to a minor side of the joint housing, such that the operating elements of the adjacent thermostats are arranged between associated access openings.

20. The system according to claim 14, wherein the joint housing includes a housing base part and a housing cover, the housing cover being latched onto the housing base part and having recesses for the operating elements.

21. The system according to claim 20, wherein the housing base part has pins that are attachable to the thermostats.

22. The system according to claim 14, wherein the joint housing is made by injection molding and has recesses for preventing material accumulation or has tool-related recesses.

23. The system according to claim 13, wherein each of the adjacent thermostats is of a same type.

24. The system according to claim 23, wherein each of the thermostats is operable to control an electrical device.

25. The system according to claim 24, wherein the device is one of a fan and a heater.

26. The system according to claim 13, wherein each of the adjacent thermostats is of a different type.
